(19) United States
(12) Patent Application Publication
(10) Pub. No.: US 2025/0025985 A1
(43) Pub. Date: Jan. 23, 2025

(54) WIRE NET MONITORING DEVICE AND MONITORING SYSTEM PROVIDED WITH MONITORING DEVICE

(71) Applicant: TCL ZHONGHUAN RENEWABLE ENERGY TECHNOLOGY CO., LTD., Tianjin (CN)

(72) Inventors: Xuzhou YANG, Tianjin (CN); Haoming ZHANG, Tianjin (CN); Rui WU, Tianjin (CN); Chen WEI, Tianjin (CN); Pengzhan ZHAO, Tianjin (CN)

(73) Assignee: TCL ZHONGHUAN RENEWABLE ENERGY TECHNOLOGY CO., LTD., Tianjin (CN)

(21) Appl. No.: 18/548,524

(22) PCT Filed: Jul. 31, 2023
(86) PCT No.: PCT/CN2023/110410

§ 371 Date: Aug. 31, 2023

(30) Foreign Application Priority Data
Aug. 31, 2022 (CN) 202211053021.0

(51) Int. Cl. B24B 49/12; F16M 11/10; F16M 11/18

(52) U.S. Cl. CPC B24B 49/12; F16M 11/10; F16M 11/18

(57) ABSTRACT

A wire net monitoring device includes at least one monitor configured to monitor at least one wire net. A signal route of the at least one monitor is configured to monitor the at least one wire net near a side of a workpiece along a rotation direction of the at least one wire net, and the signal route of the at least one monitor crosses a contact surface between the at least one wire net and the workpiece.

### CROSS-REFERENCE TO RELATED APPLICATION

The present disclosure claims priority to and the benefit of Chinese Patent Application No. 202211053021.0 filed on Aug. 31, 2022, the disclosure of which is incorporated herein by reference in its entirety.

### FIELD OF THE DISCLOSURE

The present disclosure relates to the field of crystal rod slicing processing technologies, and more particularly to a wire net monitoring device and a monitoring system provided with the monitoring device.

### BACKGROUND

The wire net state is one of the main conditions for the success of wafer processing. Due to the influence of wire net and wire bow, abnormal situations such as wire jumping or paralleling may occur during the slicing process. However, the wire jumping or paralleling may cause the wire net to be disconnected. If the wire net state is only monitored when the slicing is stopped, the abnormal state of the wire net may be enlarged. The abnormal state of the wire net cannot be known until the wire net is disconnected, which may lead to more waste chips, more waste wires of the wire net, and longer downtime. In addition, during the slicing process, a slicing room is in a closed dark state, and water mist is relatively large, therefore, it is difficult to continuously track and monitor the state of the wire net.

### SUMMARY

The present disclosure provides a wire net monitoring device and a monitoring system provided with the monitoring device, which solves the technical problem in the prior art that a state of the wire net cannot be continuously monitored in a sliced state.

In order to solve at least one of the above-mentioned technical problems, the technical solution adopted in the present disclosure is as follows.

A wire net monitoring device includes at least one monitor configured to monitor at least one wire net, a signal route of the at least one monitor is configured to monitor the at least one wire net near a side of a workpiece along a rotation direction of the at least one wire net, and the signal route of the at least one monitor crosses a contact surface between the at least one wire net and the workpiece.

In some embodiment of the present disclosure an included angle between the signal route of the at least one monitor and the contact surface between the at least one wire net and the workpiece is not greater than 90 degrees and not less than 20 degrees.

In some embodiment of the present disclosure, an included angle between the signal route of the at least one monitor and the contact surface between the at least one wire net and the workpiece is not greater than 45 degrees.

In some embodiment of the present disclosure, the at least one monitor is disposed on two sides of the workpiece and disposed opposite to each other, and the at least one monitor is configured to monitor a state of the at least one wire net on a corresponding side.

In some embodiment of the present disclosure, the wire net monitoring device includes a housing and an adjustment rod, wherein:
the at least one monitor is built in the housing and connected to the housing;
the adjustment rod is externally placed on the housing and hinged with the housing.

In some embodiment of the present disclosure, at least the housing toward which an emission port of the at least one monitor faces is set as a transparent surface;
and in some embodiment of the present disclosure, the transparent surface is disposed vertically relative to the contact surface between the at least one wire net and the workpiece.

In some embodiment of the present disclosure, the adjustment rod is suspended from a top of the housing and is located on a side of the housing away from the transparent surface.

In some embodiment of the present disclosure, a lower end of the adjustment rod is connected to a boss disposed on a top of the housing, and an end of the adjustment rod connected to the boss is configured as an arc surface structure.

In some embodiment of the present disclosure, arc holes arranged up and down opposite to each other are provided on the boss, and an arc of one of the arc holes matches an arc of an arc surface of the adjustment rod.

A monitoring system includes any one of the above the wire net monitoring devices.

The wire net monitoring device designed by the present disclosure can directly monitor the state of the wire net during the slicing process. The emission port of the monitor is oriented in the same direction as the rotation direction of the wire net, so that the wire net state can be monitored efficiently, accurately, and continuously in real time. This can comprehensively obtain abnormal basic data of the wire net, intervene in time, and avoid quality accidents. The present disclosure also proposes a monitoring system provided with the monitoring device.

### DESCRIPTION OF DRAWINGS

FIG. 1 is a perspective view of a wire net monitoring device in an embodiment.

FIG. 2 is a front view of a wire net monitoring device in an embodiment.

FIG. 3 is a schematic structural view of a boss in a wire net monitoring device in an embodiment.

FIG. 4 is a position diagram of a wire net monitoring device relative to one side of a workpiece in an embodiment.

FIG. 5 is a position diagram of a wire network monitoring device relative to two sides of a workpiece in an embodiment.

In the drawings:

| | | |
|---|---|---|
| 10: Monitoring device; | 11: Monitor; | 12: Housing; |
| 13: Transparent surface; | 14: Adjustment rod; | 15: Boss; |
| 20 Workpiece; | 30 Wire net. | |

### DETAILED DESCRIPTION OF PREFERRED EMBODIMENTS

The present disclosure will be described in detail below in conjunction with the accompanying drawings and specific embodiments.

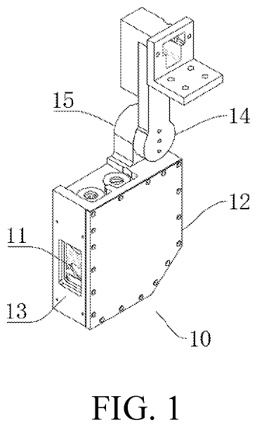

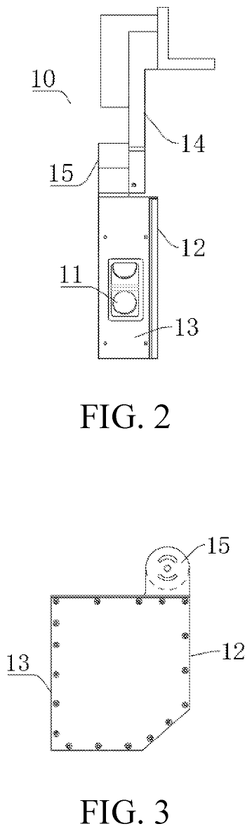

This embodiment proposes a wire net monitoring device 10, which is mainly configured to monitor a working state of the wire net 30 when a workpiece 20 is processed by multi-wire cutting. The structure of the wire net monitoring device 10 is shown in FIG. 1 to FIG. 3, including a monitor 11 configured to monitor the wire net 30 and a housing 12 configured to protect the monitor 11. The monitor 11 is built in the housing 12 and emitted light beam of the monitor 11 is disposed obliquely downward relative to a vertical transparent surface 13 where the emitted light beam irradiates toward a side of the housing 12, so as to clean and defog the transparent surface 13 when the monitor 11 is stationary. Moreover, the vertically arranged transparent surface 13 is more convenient for observing an emission port of the monitor 11. The emission port and a receiving port of the monitor 11 are arranged on the side of the transparent surface 13 of the housing 12. The emission port and the receiving port are arranged obliquely relative to a contact surface between the wire net 30 and the workpiece 20. That is, the contact surface between the wire net 30 and the workpiece 20 is inclined. That is, the emission port and the receiving port are all inclined downward toward one side of the wire net 30.

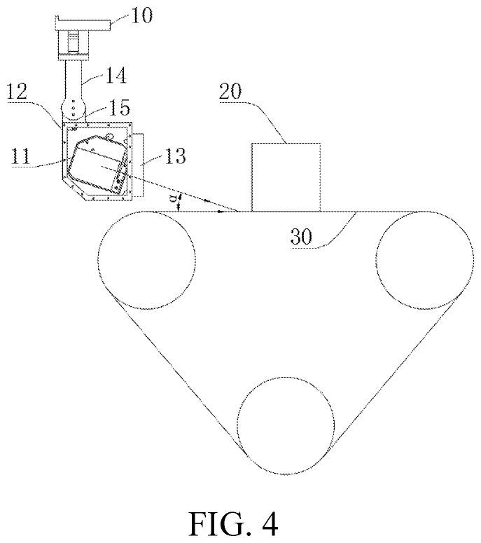

Further, the emission port of the monitor 11 monitors the wire net 30 on the side close to the workpiece 20 along the rotation direction of the wire net 30. That is, the monitor 11 moves along a longitudinal direction of the workpiece 20 and is arranged on one side in the direction in which the wire net 30 rotates. As shown in FIG. 4, the monitor 11 can monitor the state of the wire net 30 on its corresponding side, and a signal route of the monitor 11 is arranged to cross the contact surface between the wire net 30 and the workpiece 20. That is, the signal route of the monitor 11 is arranged obliquely toward the contact surface between the wire net 30 and the workpiece 20, and the included angle α is a non-obtuse angle. Regardless of the rotation direction of the wire net 30, the monitor 11 emits towards the wire net 30 in the direction in which the wire net 30 rotates, so as to monitor the wire nets in all areas of the wire nets 30. This enables an all-round and seamless position recognition of the wire nets in all areas, so that the wire nets 30 arranged along the length direction of the workpiece 20 are completely taken care of. Moreover, the inclined signal route is more conducive to the monitor 11 monitoring the state of the wire net, not only has a wide radiation area, but also the effect of irradiation is not affected by light or other devices.

Further, the included angle α between the signal route of the monitor 11 and the contact surface between the wire net 30 and the workpiece 20 is not greater than 90 degrees and not less than 20 degrees. The signal route of the monitor 11 can be arranged perpendicular to the contact surface between the wire net 30 and the workpiece 20 or can be arranged at an acute angle with the contact surface between the wire net 30 and the workpiece 20, so that the signal route of the monitor 11 cannot be interfered. If the included angle α is greater than 90 degrees, the signal route of the monitor 11 needs to be irradiated obliquely from the side of the workpiece 20 outward. This is not only detrimental to the installation of the wire net monitoring device 10, but also the workpiece 20 may block the irradiation of the signal route. Moreover, the position of the wire net 30 monitored by the monitor 11 is far away from the side where the workpiece 20 is located, so that the state of the wire net 30 cannot be accurately monitored. Since the monitor 11 is far away from the position of the workpiece 20, the measured result is not a bow value when the wire net 30 is jumped or paralleled, and even when a wire is broken, it is not easy to be observed. If the included angle α is less than 20 degrees, the signal route of the monitor 11 may be placed close to the contact surface between the wire net 30 and the workpiece 20. The monitor 11 monitors that the area of the wire net 30 is limited, and the measured bow value is not the maximum bow value in each area. This is not conducive to the observation of the state of the wire net 30. In addition, since a cooling mechanism (not shown in the figure) for cleaning the wire net 30 is provided on both sides of the workpiece 20, its location also affects the irradiation of the wire net monitoring device 10. Preferably, the included angle α between the signal route of the monitor 11 and the contact surface between the wire net 30 and the workpiece 20 is not greater than 45 degrees. This not only monitors a wide area of radiation, but also may not be interfered by other institutions. This monitors the bow value of each area in the wire net 30 more accurately and stably.

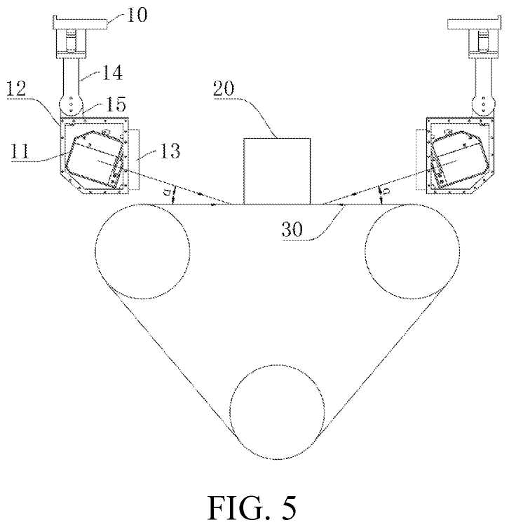

Further, the wire net monitoring device 10 can monitor the state of the wire net 30 on one side of the workpiece 20, as shown in FIG. 4. Understandably, the wire net monitoring device 10 can also monitor the state of the wire net 30 on both sides of the workpiece 20, as shown in FIG. 5. Regardless of the position setting of the wire net monitoring device 10, the bow value in each area is monitored while the wire net 30 is rotating. The direction of all the monitors 11 is set along the rotation direction of the wire net 30. That is, the state of the monitor 11 is only monitored when the wire net 30 on the same side rotates in the forward direction relative to the direction of the signal route. This prevents the reverse rotation of the wire net 30 corresponding to the signal route of the monitor 11 to cause silicon mud and cutting fluid to splash on the transparent surface 13 and avoids affecting the identification of the monitor 11.

Preferably, the monitors 11 are arranged on both sides of the workpiece and disposed opposite to each other. The monitors 11 monitor the state of the wire net 30 on the corresponding side when the wire net 30 switches between forward rotation and counter rotation. That is, the monitor 11 on the left only monitors the state of the wire net 30 when it rotates in the forward direction. The monitor 11 on the right only monitors the state of the wire net 30 during counter rotation. In addition, the counter-rotating wire net 30 is counter-rotating relative to the signal path of the monitor 11 on the right. The silicon mud and cutting fluid can be kept away from the monitor 11 on the right side along its direction of rotation, thereby ensuring the accuracy of the monitor 11 monitoring the wire net 30.

Further, the monitor 11 is a sensor capable of detecting and identifying the position and height of the wire net 30, which may be a laser sensor. This type of monitor 11 continuously and uninterruptedly monitors the position of the wire net 30 in each area. Especially in the slicing room where the light is dark during slicing, the position detection of the wire net 30 can be completed without being affected by the amount of water mist. The monitor 11 can be fixed at a certain position to detect the wire net 30 and can also move back and forth along the length direction of the wire net 30 to detect the wire net 30.

Taking the monitor 11 as a laser sensor as an example, during operation, the monitor 11 can detect position information of the wire net 30 in each wire groove through laser pulses during the slicing process. The transmitted signal is transmitted to the reflective object wire net 30 and then reflected back to the monitor 11 by the wire net 30, and then the detection signal of the wire net 30 in each wire groove can be collected. The monitor 11 then transmits the detection signal to an external central unit for analysis and processing (not shown in the figure) for processing, so as to convert the collected detection signal into a digital signal, l, and then analyze and optimize to obtain a curve image that can be used to characterize the state of the wire net. Therefore, the graph of time-bow value and the graph of area-bow value can be visually monitored. Such drawings can be converted based on the obtained test data, and the graphs of each graph are omitted here. From the graph, it can be directly determined whether the state of the wire net 30 is normal, that is, whether there are abnormal problems such as wire jumping, paralleling or disconnection, etc., which is effective and covers the whole process. Of course, when the cutting feed reaches the preset threshold, the monitor 11 can still detect the bows of all the cutting wires in the wire net 30. The formed bow curve diagram is compared with the bow curve diagram during standard through-cutting, and it can also be determined whether the workpiece 20 has been cut through. In this way, the risk of misjudgment or missed judgment caused by monitoring the wire net by taking pictures with a camera in the prior art can be avoided. Further, it is not affected by the light intensity, not only has strong practical effect but also has high judgment accuracy and can monitor the working state of the wire net 30 in real time.

Further, the housing 12 is a flat structure, which is adapted to the structure of the monitor 11. On the top of the housing 12 there is also an adjustment rod 14 configured to adjust the direction of the light beam of the monitor 11. The monitor 11 is built in the housing 12 and fixedly connected with the housing 12. The adjustment rod 14 is placed outside the top of the housing 12 and is hinged to a boss 15 on the top of the housing 12.

In the housing 12, except that the emission port close to the monitor 11 is set as a transparent structure, other wall surfaces may also be set as transparent structures or non-transparent structures. The housing 12 is a closed structure, which not only prevents dust and water, but also prevents cleaning liquid from accumulating into it. The housing 12 can be made of materials with high temperature resistance, moisture resistance and electrical interference resistance.

Further, at least the housing 12 facing the emission port of the monitor 11 is set as a transparent surface 13. Preferably, the transparent surface 13 is arranged perpendicular to the contact surface between the wire net 30 and the workpiece 20. This facilitates the cleaning mechanism disposed opposite to the transparent surface 13 to directly clean the transparent surface 13 of the housing 12, so as to quickly clean the cutting fluid or silicon mud adhering to the transparent surface 13. This makes the water liquid after cleaning to be blown dry quickly, completes the drying of the outer wall surface of the transparent surface 13, thereby ensuring the cleaning effect of the environment of the monitor 11 when it is working.

Further, the adjustment rod 14 is suspended from the top of the housing 12 and is located on a side of the housing 12 away from the transparent surface 13. The arc surface of the adjustment rod 14 is configured along the length direction of the top of the housing 12 and abuts against the top of the housing 12. This controls the housing 12 to rotate along the arc surface end of the adjustment rod 14 with a connection point between the adjustment rod 14 and the boss 15 as the center of the circle, so as to adjust the position of the housing 12 so that the emission port of the monitor 11 is tilted toward the wire net or vertically configured.

Further, the lower end of the adjustment rod 14 is connected to the boss 15 arranged on the top of the housing 12. One end of the adjustment rod 14 connected to the boss 15 is configured as an arc surface structure, and the other end is arranged vertically and connected with other fixed blocks. The connection point between the adjustment rod 14 and the boss 15 is located at the end of the housing 11 away from the emission port of the monitor 11. The boss 15 is hinged to the adjustment rod 14. The end of the adjustment rod 14 close to the housing 12 has a circular arc surface structure, which can facilitate the adjustment of the position angle of the housing 12 relative to the wire net 30 to adjust the positions of the emission port and the receiving port of the monitor 11. After the adjustment of the monitor 11 is completed, the adjustment rod 14 is connected to the boss 15 through a screw rod, so that the position angle of the monitor 11 relative to the wire net 30 is adjusted, and the monitor 11 is completely fixed in the housing 12.

As shown in FIG. 3, arc holes arranged up and down opposite to each other are provided on the boss 15. The radian of the arc hole matches the arc of the arc surface of the adjustment rod 14. This structure is more conducive to the relative rotation adjustment of the adjustment rod 14 and the housing 12. This can quickly and accurately rotate the housing 12 into place and make the housing 12 fixedly connected with the adjustment rod 14 through the boss 15.

A monitoring system is provided with the wire net monitoring device 10 described in any one of the above.

The wire net monitoring device designed by the present disclosure can directly monitor the state of the wire net during the slicing process. The emission port of the monitor is oriented in the same direction as the rotation direction of the wire net, so that the wire net state can be monitored efficiently, accurately, and continuously in real time. This can comprehensively obtain abnormal basic data of the wire net, intervene in time, and avoid quality accidents. The present disclosure also proposes a monitoring system provided with the monitoring device.

The embodiments of the present disclosure have been described in detail above. The content described is only a preferred embodiment of the present disclosure and cannot be considered as limiting the implementation scope of the present disclosure. All equal changes and improvements made according to the claims of the present disclosure should still belong to the scope covered by the present disclosure.

What is claimed is:

1. A wire net monitoring device, comprising:
at least one monitor configured to monitor at least one wire net, wherein a signal route of the at least one monitor is configured to monitor the at least one wire net near a side of a workpiece along a rotation direction of the at least one wire net, and the signal route of the at least one monitor crosses a contact surface between the at least one wire net and the workpiece.

2. The wire net monitoring device according to claim 1, wherein an included angle between the signal route of the at least one monitor and the contact surface between the at least one wire net and the workpiece is not greater than 90 degrees and not less than 20 degrees.

3. The wire net monitoring device according to claim 2, wherein an included angle between the signal route of the at least one monitor and the contact surface between the at least one wire net and the workpiece is not greater than 45 degrees.

4. The wire net monitoring device according to claim 2, wherein the at least one monitor is disposed on two sides of the workpiece and disposed opposite to each other, and the at least one monitor is configured to monitor a state of the at least one wire net on a corresponding side.

5. The wire net monitoring device according to claim 1, further comprising a housing and an adjustment rod, wherein:
the at least one monitor is built in the housing and connected to the housing;
the adjustment rod is externally placed on the housing and hinged with the housing.

6. The wire net monitoring device according to claim 5, wherein at least the housing toward which an emission port of the at least one monitor faces is set as a transparent surface;
the transparent surface is disposed vertically relative to the contact surface between the at least one wire net and the workpiece.

7. The wire net monitoring device according to claim 6, wherein the adjustment rod is suspended from a top of the housing and is located on a side of the housing away from the transparent surface.

8. The wire net monitoring device according to claim 6, wherein a lower end of the adjustment rod is connected to a boss disposed on a top of the housing, and an end of the adjustment rod connected to the boss is configured as an arc surface structure.

9. The wire net monitoring device according to claim 8, wherein arc holes arranged up and down opposite to each other are provided on the boss, and an arc of one of the arc holes matches an arc of an arc surface of the adjustment rod.

10. A monitoring system, comprising:
a wire net monitoring device, comprising:
at least one monitor configured to monitor at least one wire net, wherein a signal route of the at least one monitor is configured to monitor the at least one wire net near a side of a workpiece along a rotation direction of the at least one wire net, and the signal route of the at least one monitor crosses a contact surface between the at least one wire net and the workpiece.

11. The monitoring system according to claim 10, wherein an included angle between the signal route of the at least one monitor and the contact surface between the at least one wire net and the workpiece is not greater than 90 degrees and not less than 20 degrees.

12. The monitoring system according to claim 11, wherein an included angle between the signal route of the at least one monitor and the contact surface between the at least one wire net and the workpiece is not greater than 45 degrees.

13. The monitoring system according to claim 11, wherein the at least one monitor is disposed on two sides of the workpiece and disposed opposite to each other, and the at least one monitor is configured to monitor a state of the at least one wire net on a corresponding side.

14. The monitoring system according to claim 10, further comprising a housing and an adjustment rod, wherein:
the at least one monitor is built in the housing and connected to the housing;
the adjustment rod is externally placed on the housing and hinged with the housing.

15. The monitoring system according to claim 14, wherein at least the housing toward which an emission port of the at least one monitor faces is set as a transparent surface;
the transparent surface is disposed vertically relative to the contact surface between the at least one wire net and the workpiece.

16. The monitoring system according to claim 15, wherein the adjustment rod is suspended from a top of the housing and is located on a side of the housing away from the transparent surface.

17. The monitoring system according to claim 15, wherein a lower end of the adjustment rod is connected to a boss disposed on a top of the housing, and an end of the adjustment rod connected to the boss is configured as an arc surface structure.

18. The wire net monitoring device according to claim 17, wherein arc holes arranged up and down opposite to each other are provided on the boss, and an arc of one of the arc holes matches an arc of an arc surface of the adjustment rod.
